(19) United States
(12) Patent Application Publication
(10) Pub. No.: US 2017/0043834 A1
(43) Pub. Date: Feb. 16, 2017

(54) METHOD FOR CONTROLLING A FRONT LAMP, AND BICYCLE

(71) Applicants: Le Holdings(Beijing)Co., Ltd., Beijing (CN); LETV SPORTS CULTURE DEVELOP (BEIJING) CO., LTD., Beijing (CN)

(72) Inventor: Dalong LI, Beijing (CN)

(21) Appl. No.: 15/222,573

(22) Filed: Jul. 28, 2016

Related U.S. Application Data
(63) Continuation of application No. PCT/CN2016/081992, filed on May 13, 2016.

(30) Foreign Application Priority Data
Aug. 11, 2015 (CN) 201510491509.5

(51) Int. Cl. B62J 6/02; F21V 23/00; B62K 3/02; F21V 23/04; B62J 6/16; B62J 6/00

(52) U.S. Cl. CPC B62J 6/02; B62J 6/16; B62J 6/001; B62K 3/02; F21V 23/0464; F21V 23/003; B62K 2207/00; B62J 2300/002; F21Y 2115/10

(57) ABSTRACT

Disclosed are a method for controlling a front lamp, and a bicycle, and the bicycle includes: a control apparatus, a button arranged on the bicycle body, and a front lamp fixed on the front end of the bicycle body, wherein the control apparatus is connected with the button and the front lamp; the control apparatus is configured to control the front lamp according to a result of the button being triggered. In the disclosure, the front lamp is fixed on the bicycle body, and the button is arranged on the bicycle body to control the front lamp, so that a bicycling user can operate directly on the button on the bicycle to control the front lamp, and thus the bicycling user can control the front lamp by triggering the button on the vehicle body, where the user can operate conveniently, thus improving the experience of the bicycle rider.

### CROSS REFERENCE TO RELATED APPLICATIONS

This application is a continuation of International Application No. PCT/CN2016/081992, filed on May 13, 2016, which is based upon and claims priority to Chinese Patent Application No. 201510491509.5, filed with the Chinese Patent Office on Aug. 11, 2015 and entitled “Method for controlling a front lamp, and bicycle”, which is hereby incorporated by reference in its entirety.

### TECHNICAL FIELD

The present disclosure relates to the field of communications, and particularly to a method for controlling a front lamp, and a bicycle.

### BACKGROUND

At present, bicycling has become increasingly popular as a low-carbon, environment-conserving, and healthy sporting and traveling mode. A user bicycling at night needs to be provided with an illuminating device for his or her bicycling so that the user can bicycle normally and securely at night.

At present the user can not control the illuminating device through his or her bicycle, but instead the user has to control the illuminating device through a power key provided thereon, so that if the bicycling user is turning on or off the illuminating device, then the bicycling user may suffer from a hidden risk of his or her security while bicycling.

In view of this, it is highly desirable at present in the industry to enable the bicycling user to control the illuminating device while guaranteeing the security of the bicycling user.

### SUMMARY

Embodiments of the disclosure provide a method for controlling a front lamp, and a bicycle so as to address the problem in the prior art of a possible hidden risk of the bicycling user if the bicycling user turns on or off the illuminating device, by enabling the bicycling user to control the illuminating device while guaranteeing the security of the bicycling user.

An embodiment of the disclosure provides a bicycle including a bicycle body, and further including:
a control apparatus, a button arranged on the bicycle body, and a front lamp fixed on the front end of the bicycle body, wherein the control apparatus is connected with the button and the front lamp; the control apparatus is configured to control the front lamp according to a result of the button being triggered.

An embodiment of the disclosure provides a method for controlling a front lamp, wherein the front lamp is arranged on the front end of a bicycle body, the bicycle comprising a control apparatus and a button arranged on the bicycle body, and the control apparatus is connected with the button and the front lamp, the method including:
the control apparatus obtains a result of the button being triggered; and the control apparatus controls the front lamp according to a result of the button being triggered.

With the method for controlling a front lamp, and the bicycle according to the embodiments of the disclosure, the front lamp is fixed on the front end of the bicycle body, and the button is arranged on the bicycle body to control the front lamp, so that a bicycling user can operate directly on the button on the bicycle to control the front lamp, and thus the bicycling user can control the front lamp by triggering the button on the vehicle body, where the user can operate conveniently, thus improving the experience of the bicycle rider.

### BRIEF DESCRIPTION OF THE DRAWINGS

One or more embodiments are illustrated by way of example, and not by limitation, in the figures of the accompanying. drawings, wherein elements having the same reference numeral designations represent like elements throughout. The drawings are not to scale, unless otherwise disclosed.

FIG. 1 is a schematic structural diagram of a bicycle according to an embodiment of the disclosure

FIG. 2 is a schematic explosively structural diagram of a control apparatus cooperating with a bicycle body of the bicycle according to an embodiment of the disclosure; and

FIG. 3 is a flow chart of a method for controlling a front lamp according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

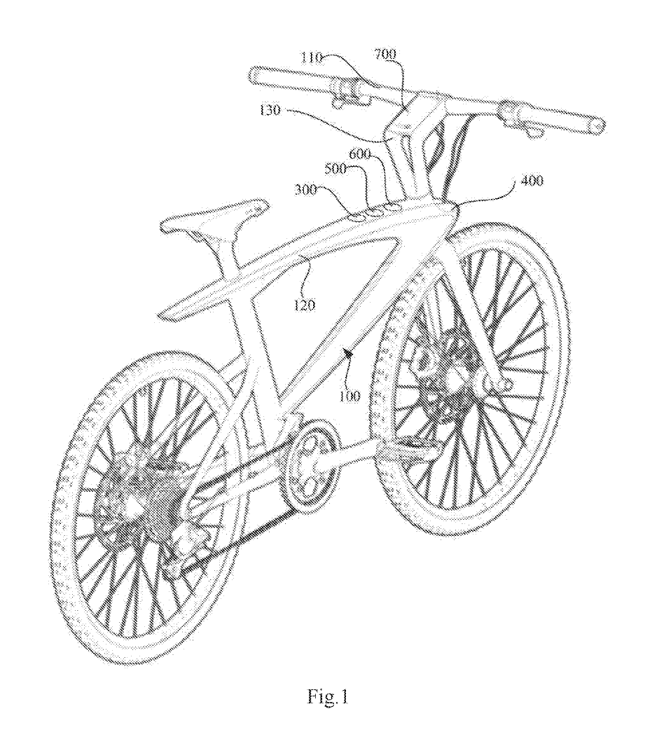

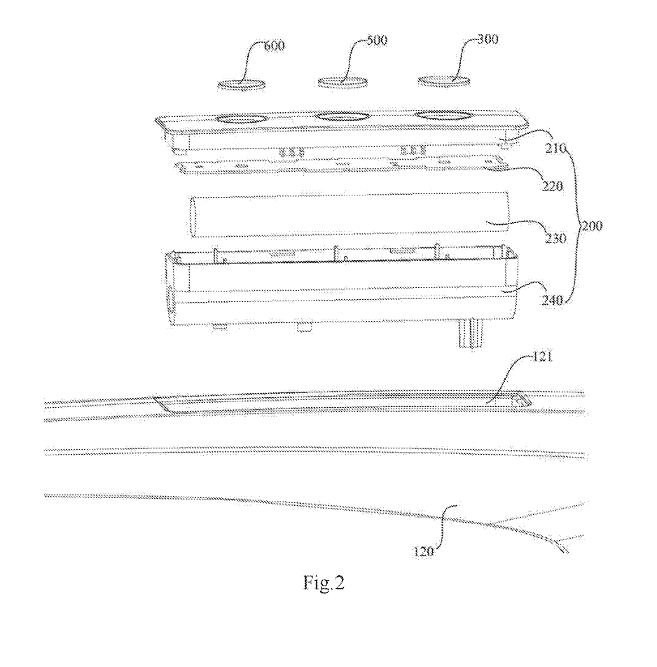

As illustrated in FIG. 1 and FIG. 2, a bicycle according to an embodiment of the disclosure includes a bicycle body 100, and further includes:
A control apparatus 200, a button 300 arranged on the bicycle body 100, and a front lamp 400 fixed on the front end of the bicycle body 100, where the control apparatus 200 is connected with the button 300 and the front lamp 400 and the control apparatus 200 is configured to control the front lamp 400 according to a result of the button 300 being triggered.

Particularly if a user is bicycling in an environment with dark light rays, then the front lamp 400 will be configured to illuminate for the user so that the user can see clearly the condition of a front road for traveling.

In an embodiment, the front lamp 400 is fixed on the front end of the bicycle body, and the button 300 configured to control the front lamp 400 is arranged on the bicycle body 100, so that the bicycling user can operate directly on the button 300 arranged on the bicycle body 100 to control the front lamp 400, and in this way, the bicycling user can control the front lamp 400 by triggering the button 300 on the bicycle body 100, where the user can operate conveniently for a better experience of the bicycle rider.

Particularly, as illustrated in FIG. 2, a beam 120 of the bicycle body 100 is structured as a cavity, and as illustrated in FIG. 1, the button 300 is arranged on an upper wall of the beam 120 of the bicycle body 100, and a button cap of the button 300 is exposed on the surface of the upper wall of the beam 120. A button for another purpose can also be arranged on the beam, e.g., an image button 500 configured to control an image acquisition device on the bicycle body 100, a lock button 600 configured to control an electronic lock on the bicycle body 100, etc., FIG. 2 illustrates the cavity 121 of the beam with a part of the upper wall of the beam being exposed.

In an embodiment of the disclosure, the button 300 is arranged on the beam 120 of the bicycle body 100 so that the bicycling user can operate on the button 300 conveniently. Moreover the button 300 can be arranged on the beam 120 without adding any further element on the bicycle 100 and while making full use of a space of the beam 120 of the bicycle 100. Of course, the button 300 can alternatively be arranged on a bicycle handle 110 of the bicycle 100.

Particularly the button 300 is wired to the control apparatus 200, and a cable connecting the button 300 and the control apparatus 200 travels through the cavity in the beam 120 of the bicycle 100.

In an embodiment of the disclosure, the cable between the button 300 and the control apparatus 200 travels through the cavity in the beam 120 of the bicycle 100, so that the cable can be avoided from being exposed outside the bicycle 100 to thereby guarantee the lifetime of the cable.

Particularly the front lamp 400 is fixed on the bicycle handle 110 of the bicycle body 100 through a first bracket fixed on the bicycle handle 110 of the bicycle body 100, or the front lamp 400 can alternatively be embedded on the bicycle handle. although the disclosure will not be limited thereto.

In an embodiment of the disclosure, the front lamp 400 is fixed through the first bracket so that the front lamp 100 can be fixed on the handle 110, and preferably the front lamp 400 can be removed from the first bracket; and preferably the front lamp 400 is installed centrally on the bicycle handle 110.

Particularly as illustrated in FIG. 1, the front lamp 400 is fixed on the front end of the beam 120 of the bicycle body 100, where the front end of the beam refers to an end of the beam on an upper side of a front wheel of the bicycle.

Particularly the control apparatus 200 is fixed on the bicycle handle 110 of the bicycle body 100 through a second bracket arranged on the bicycle handle of the bicycle body, or the control apparatus 200 can alternatively be fixed in the cavity 121 in the beam.

Particularly as illustrated in FIG. 1 the bicycle according to the respective embodiments above further includes:
A third bracket 130, and a front component body 700 embedded at the third bracket 130, where the third bracket 130 is connected with the bicycle handle 110 of the bicycle body 100, and a bicycle frame of the bicycle body 100, and the control apparatus 200 is arranged in the front component body 700 and connected with the front component body 700.

In an embodiment of the disclosure, the bicycle body other than the bicycle handle 110 will be referred collectively to as the bicycle frame.

The front component body 700 in an embodiment of the disclosure includes a first lower housing, a circuit board, a second battery, an upper housing, a display screen, and a touch screen arranged sequentially from the inner side to the outer side, where:
The first lower housing is connected with the bracket, the upper housing is connected with the first lower housing, and the circuit board and the second battery are located in an accommodating space defined by the first lower housing and the upper housing; and the display screen and the touch screen are arranged on the outside surface of the upper housing.

In an embodiment of the disclosure, a front component is added to the bicycle, and the state of the button 300 on the bicycle body being triggered, and the state of the front lamp being turned on or off can be displayed on a screen of the front component, and furthermore operations of playing music, navigation, bicycle management, etc., can be performed by operating on the screen of the front component, thus facilitating intelligent control on the bicycle.

Particularly as illustrated in FIG. 2, the beam 120 of the bicycle body 100 is structured as a cavity.

Here the control apparatus 200 can be arranged in the cavity 121 of the beam 120, and the button 300 can be arranged on the control apparatus 200, where the button cap of the button 300 is exposed on the surface of the upper wall of the beam 120 of the bicycle body: Of course, the button 300 can alternatively be arranged on the sidewall of the beam.

In an embodiment of the disclosure, the control apparatus is arranged in the cavity of the beam to thereby make full use of the space of the bicycle body and also avoid the control apparatus from being exposed outside the vehicle body so that the lifetime of the control apparatus can be improved to some extent. The button cap of the button is exposed on the surface of the upper wall on the beam of the bicycle body so that the user can operate on the button conveniently.

Particularly the control apparatus 200 can be arranged in the cavity in the beam as illustrated in FIG. 2, and the control apparatus 200 includes a control panel 210, a control circuit board 220, and a first battery 230, where the control panel 210 is connected to the control circuit board 220, the control circuit board 220 is connected to the first battery 230, and the button 300 is arranged on the control panel 210; and the control apparatus 200 can be arranged in the cavity 121 in the beam. The control apparatus 200 further includes a second lower housing 240 defining together with the control panel 210 an accommodating cavity in which the first battery 230, the control circuit board 220, etc., are installed; and in an embodiment of the disclosure, the control panel 210 and the second lower housing 240 can protect the first battery 230, the control circuit board 220, etc.

Particularly the bicycle according to the respective embodiments above further includes:

A light ray sensor connected with the control apparatus, and an LED lamp fixed on the wall of the button cap of the button and connected with the control apparatus; and the control apparatus is further configured to control the LED lamp to be turned on or off, according to the strength of light acquired by the light ray sensor.

In an embodiment of the disclosure, a Light Emitting Diode (LED) lamp is arranged on the wall of the button cap, and controlled to be turned on or off, using the light ray sensor connected with the control apparatus, so that if the user is bicycling in an environment with dark light rays, then the LED lamp will be turned on to notify the bicycle rider of the position of the button 300 so that the bicycle can operate on the button conveniently. Preferably the LED lamp is embedded in the wall of the button cap so that the tip of the LED lamp is located at the same level as the wall of the button cap.

Particularly the control apparatus 200 can be wired to the front lamp 400, or connected therewith through Bluetooth engagement; or can be connected therewith through WiFi.

Particularly the control apparatus 200 is configured:
To control the front lamp 400 to be turned on, upon determining that the button 300 has been triggered for a first preset number of times in a first preset length of time; and to control the front lamp 400 to be turned off, upon determining that the button 300 has been triggered for a second preset number of times in the first preset length of time.

In an embodiment of the disclosure, the control apparatus controls the front lamp to be turned on or off, by detecting the state of the button 300 being triggered, so that the bicycling user can decide to turn on or off the front lamp, by operating on the button 300 on the beam, thus improving the experience of the bicycle rider, where the first preset number is preferably 1, and the second preset number is preferably 2, or the first preset number is preferably 2, and the second preset number is preferably 1. The first preset number and the second preset number can alternatively be other values instead of being limited thereto as long as the first preset number is different from the second preset number.

Particularly the control apparatus 200 is configured:
To control the front lamp 400 to vary from being bright to being dark in brightness, upon determining that the button 300 has been triggered for a second preset length of time; or
To control the front lamp 400 to vary from being dark to being bright in brightness, upon determining that the button 300 has been triggered for a second preset length of time.

In an embodiment of the disclosure, the control apparatus controls the brightness of the front lamp by detecting the state of the button 300 being triggered, so that the bicycling user can decide on the brightness of the front lamp by operating on the button 300 on the beam, thus improving the experience of the bicycle rider, where the front lamp 400 varies from being bright to being dark in brightness, or from being dark to being bright in brightness at some step of brightness.

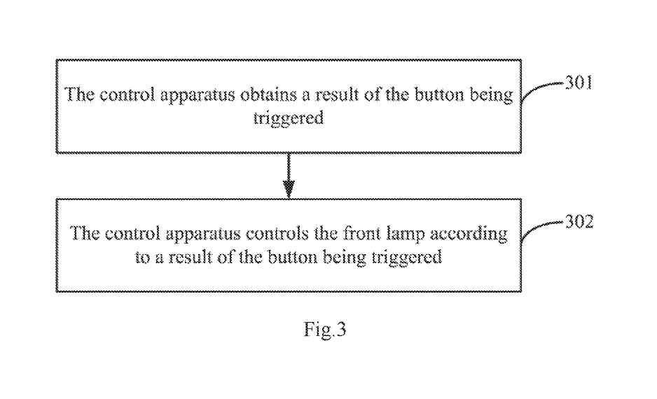

Referring to FIG. 3, an embodiment of the disclosure further provides a method for controlling a front lamp, wherein the front lamp is arranged on the front end of a bicycle body, the bicycle comprising a control apparatus and a button arranged on the bicycle body, and the control apparatus is connected with the button and the front lamp, the method including:
Step 301, the control apparatus obtains a result of the button being triggered; and
Step 302, the control apparatus controls the front lamp according to a result of the button being triggered.

Preferably the control apparatus controls the front lamp according to a result of the button being triggered as follows:
Controlling the front lamp to be turned on, upon determining that the button has been triggered for a first preset number of times in a first preset length of time; and
Controlling the front lamp to be turned off, upon determining that the button has been triggered for a second preset number of times in the first preset length of time.

Preferably the control apparatus controls the front lamp according to a result of the button being triggered as follows:
Controlling the front lamp to vary from being bright to being dark in brightness, upon determining that the button has been triggered for a second preset length of time; or
Controlling the front lamp to vary from being dark to being bright in brightness, upon determining that the button has been triggered for a second preset length of time.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A bicycle, comprising a bicycle body, wherein the bicycle fu her comprises:
a control apparatus, a button arranged on the bicycle body, and a front lamp fixed on the front end of the bicycle body, wherein the control apparatus is connected with the button and the front lamp; the control apparatus is configured to control the front lamp according to a result of the button being triggered.

2. The bicycle according to claim 1, wherein a beam of the bicycle body is structured as a cavity, the button is arranged on an upper wall of the beam of the bicycle body, and a button cap of the button is exposed on the surface of the upper wall of the beam.

3. The bicycle according to claim 2, wherein the button is wired to the control apparatus, and a. cable connecting the button and the control apparatus travels through the cavity in the beam of the bicycle.

4. The bicycle according to claim 1, wherein the front lamp is fixed on a bicycle handle of the bicycle body through a first bracket fixed on the bicycle handle of the bicycle body.

5. The bicycle according to claim 1, wherein the front lamp is fixed on the front end of a beam of the bicycle body.

6. The bicycle according to claim 1, wherein the control apparatus is fixed on a bicycle handle of the bicycle body through a second bracket arranged on the bicycle handle of the bicycle body.

7. The bicycle according to claim 1, wherein the bicycle further comprises:
a third bracket, and a front component body embedded at the third bracket, wherein the third bracket is connected with a bicycle handle of the bicycle body, and a bicycle frame of the bicycle body, and the control apparatus is arranged in the front component body and connected with the front component body.

8. The bicycle according to claim 1, wherein a beam of the bicycle body is structured as a cavity, the control apparatus is arranged in the cavity of the beam, and the button is arranged on the control apparatus so that the button cap of the button is exposed on the surface of the upper wall of the beam of the bicycle body.

9. The bicycle according to claim 8, wherein the control apparatus comprises a control panel, a control circuit board, and a first battery, the control panel is fixed to the control circuit board, the control circuit board is fixed to the first battery, and the button is arranged on the control panel.

10. The bicycle according to claim 1, wherein the bicycle further comprises:
a light ray sensor connected with the control apparatus, and an LED lamp fixed on the wall of a button cap of the button and connected with the control apparatus; wherein the control apparatus is further configured to control the LED lamp to be turned on or off, according to the strength of light acquired by the light ray sensor.

11. The bicycle according to claim 1, wherein the control apparatus is configured:
to control the front lamp to be turned on, upon determining that the button has been triggered for a first preset number of times in a first preset length of time; and to control the front lamp to be turned off, upon determining that the button has been triggered for a second preset number of times in the first preset length of time.

12. The bicycle according to claim 1, wherein the control apparatus is configured:
to control the front lamp to vary from being bright to being dark in brightness, upon determining that the button has been triggered for a second preset length of time; or
to control the front lamp to vary from being dark to being bright in brightness, upon determining that the button has been triggered for a second preset length of time.

13. A method for controlling a front lamp, wherein the front lamp is arranged on the front end of a bicycle body, the bicycle comprising a control apparatus and a button arranged on the bicycle body, and the control apparatus is connected with the button and the front lamp, the method comprising:
the control apparatus obtains a result of the button being triggered; and
the control apparatus controls the front lamp according to the result of the button being triggered.

14. The method according to claim 13, wherein the control apparatus controls the front lamp according to a result of the button being triggered, by:
controlling the front lamp to be turned on, upon determining that the button has been triggered for a first preset number of times in a first preset length of time; and
controlling the front lamp to be turned off, upon determining that the button has been triggered for a second preset number of times in the first preset length of time.

15. The method according to claim 13, wherein the control apparatus controls the front lamp according to a result of the button being triggered, by:
controlling the front lamp to vary from being bright to being dark in brightness, upon determining that the button has been triggered for a second preset length of time; or
controlling the front lamp to vary from being dark to being bright in brightness, upon determining that the button has been triggered for a second preset length of time.
